(19) United States
(12) Patent Application Publication
(10) Pub. No.: US 2014/0232253 A1
(43) Pub. Date: Aug. 21, 2014

(54) LIGHT EMITTING DIODE DEVICE

(71) Applicant: CAL-COMP ELECTRONICS & COMMUNICATIONS COMPANY LIMITED, New Taipei City (TW)

(72) Inventors: Chung-Chu Lee, New Taipei City (TW); Chih-Feng Lin, New Taipei City (TW)

(73) Assignee: Cal-Comp Electronics & Communications Company Limited, New Taipei City (TW)

(21) Appl. No.: 13/831,963

(22) Filed: Mar. 15, 2013

(30) Foreign Application Priority Data
Feb. 21, 2013 (TW) 102106060

(51) Int. Cl. F21K 99/00

(52) U.S. Cl. CPC F21K 9/50
USPC 313/113

(57) ABSTRACT

A light emitting diode device including a base, at least one light emitting diode, a bulb, and a patterned reflective layer is provided. The light emitting diode and the bulb are both disposed on the base. The bulb has a side-wall and a reflective surface, wherein the side-wall surrounds the light emitting diode and the reflective surface connected with the side-wall is located above and facing the light emitting diode. The patterned reflective layer is disposed on the reflective surface. The light emitting diode device has side-emitting effects that a user desired by the co-disposition of the patterned reflective layer and the reflective surface.

### CROSS-REFERENCE TO RELATED APPLICATION

This application claims the priority benefit of Taiwan application serial no. 102106060, filed on Feb. 21, 2013. The entirety of the above-mentioned patent application is hereby incorporated by reference herein and made a part of this specification.

### TECHNICAL FIELD

The disclosure relates to a light emitting diode device, and particularly relates to a light emitting diode device with side-emitting effect.

### BACKGROUND

In our daily lives, since light emitting diodes (LED) light source have the advantages of compactness and long lifetime, light emitting diodes as a light source have become a very common application.

In the conventional application of LED light source, since the LED light source is a light source with a directive property, a direct incidence area in front of the LED light source usually has a higher brightness, whereas a non-direct incidence area usually has brightness lower than the direct incidence area. Due to the directive property of the LED light source, the LED light source is mostly applied in a light-emitting device in which a high brightness of a specific area is desired. When the LED light source is applied in a decorative light-emitting device, there are usually disadvantages of non-uniform brightness and a smaller viewing angle.

### SUMMARY

The disclosure provides a light emitting diode device having a side-emitting effect.

The light emitting diode device of the disclosure includes a base, a light emitting diode, a bulb, and a patterned reflective layer. The light emitting diode and the bulb are disposed on the base, wherein the bulb has a side-wall and a reflective surface, the side-wall surrounds the light emitting diode, the reflective surface is located above the light emitting diode and faces the light emitting diode, the reflective surface and the side-wall are connected, and the patterned reflective layer is disposed on the reflective surface.

In view of the foregoing, disposing the reflective surface and the patterned reflective layer allows the light of light emitting diode as a directive light source to be reflected to the base, thereby increasing the side-emitting effect of the light emitting diode device.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating a light emitting diode device according to a first embodiment of the disclosure.

FIG. 2 is a schematic view illustrating a sub-surface of a reflective surface of the light emitting diode device of FIG. 1 being an inclined plane.

FIG. 3 is a schematic view illustrating that the sub-surface is an arc plane.

FIG. 4 is a schematic view illustrating that the sub-surface is formed of planes with different slopes.

FIG. 5 is a schematic view illustrating that a patterned reflective layer distributed on a reflective surface in a form of point.

FIG. 6 is a schematic view illustrating that a patterned reflective layer formed on a reflective surface in a form of hollow pattern.

FIG. 7 is a schematic view illustrating that a patterned reflective layer covers a complete reflective surface.

FIG. 8 is a schematic view illustrating a light track when the light emitting diode device of FIG. 1 emits a light.

FIG. 9 is a schematic view illustrating a light shape when the light emitting diode device of FIG. 5 emits a light.

FIG. 10-1 is a schematic view illustrating a reflective surface at another slope.

FIG. 10-2 is a schematic view illustrating a light shape of the light emitting diode device of FIG. 10-1.

FIG. 11 is a schematic view illustrating a light emitting diode device according to a second embodiment of the disclosure.

FIG. 12 is a schematic view illustrating a light emitting diode device of the disclosure according to a third embodiment.

FIG. 13 is a schematic view illustrating a light emitting diode device of the disclosure according to a fourth embodiment.

FIG. 14 is a schematic view illustrating a light track when a reflective block has a notch.

FIG. 15 is a schematic view illustrating a light track when the light emitting diode device of FIG. 14 emits light.

FIG. 16-1 is a schematic view illustrating a light emitting diode device of the disclosure according to a fifth embodiment.

FIG. 16-2 is a schematic view illustrating a light shape of the light emitting diode device of FIG. 16-1.

### DETAILED DESCRIPTION OF DISCLOSED EMBODIMENTS

### First Embodiment

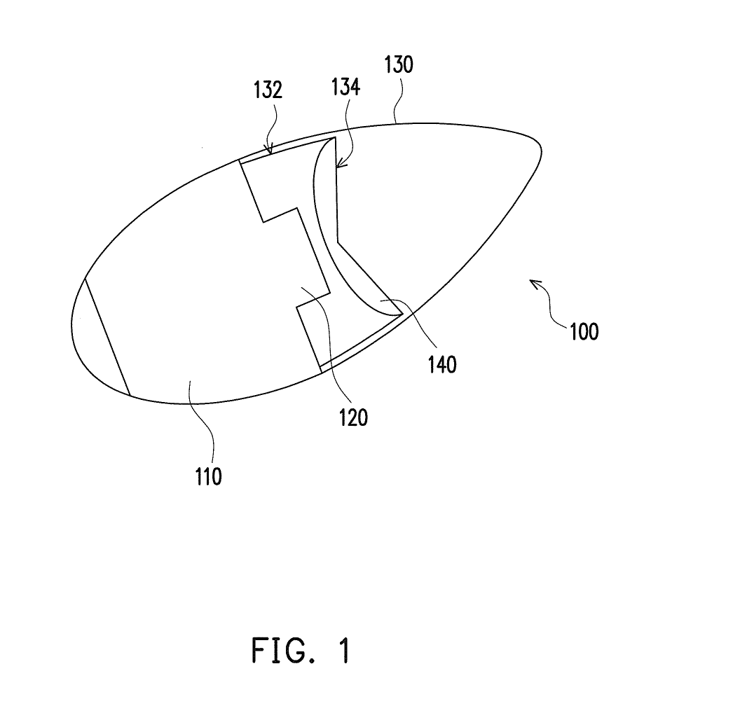

FIG. 1 is a schematic view illustrating a light emitting diode device according to a first embodiment of the disclosure. Referring to FIG. 1, a light emitting diode device 100 of this embodiment includes a base 110, a light emitting diode 120, a bulb 130, and a patterned reflective layer 140. The light emitting diode 120 and the bulb 130 are disposed on the base 110, wherein the bulb 130 has a side-wall 132 and a reflective surface 134, the side-wall 132 surrounds the light emitting diode 120, the reflective surface 134 is located above the light emitting diode 120 and faces the light emitting diode 120, the reflective surface 134 and the side-wall 132 are connected, and the patterned reflective layer 140 is disposed on the reflective surface 134.

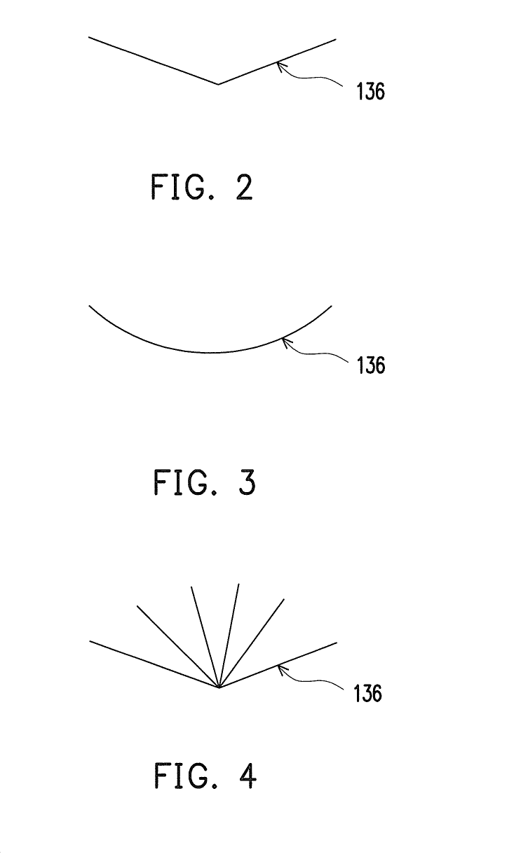

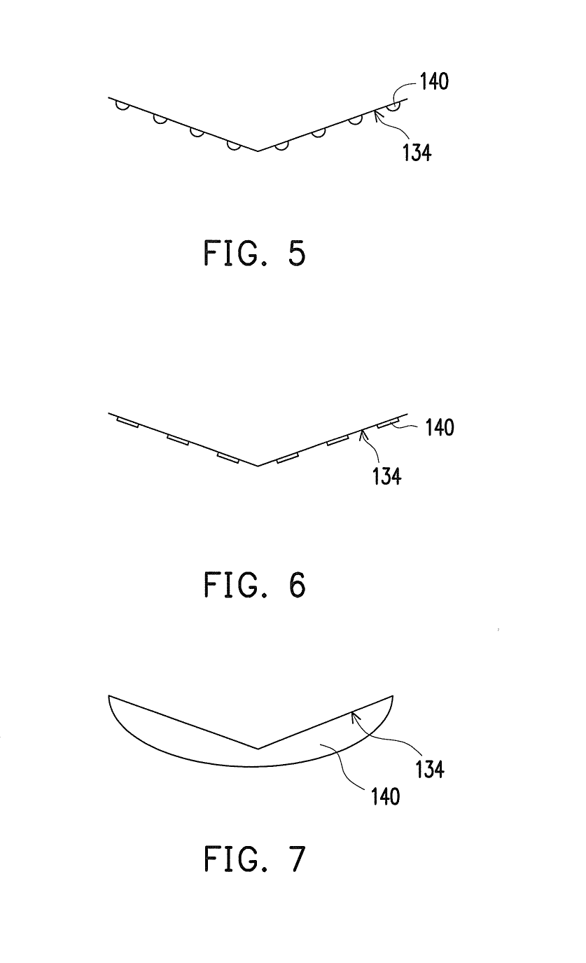

More specifically, the reflective surface 134 is formed of a plurality of sub-surfaces 136, wherein the sub-surfaces 136 of the reflective surface 134 of this embodiment intersect at a point. The sub-surfaces 136 may be an inclined plane (as shown in FIG. 2), an arc plane (as shown in FIG. 3), planes having different slopes (as shown in FIG. 4), or a combination of at least one of the planes described above. The user may decide in accordance with practical needs. The sub-surfaces 136 of the reflective surface 134 of the light emitting diode device 100 of this embodiment is described with the inclined plane shown in FIG. 2. However, the disclosure is not limited thereto. People skilled in the art may modify a possible form of the sub-surfaces 136 in accordance with practical needs based on the contents described herein. In addition, the patterned reflective layer 140 covers at least a portion of the reflective surface 134. The patterned reflective layer 140 may be distributed on the reflective surface 134 in a form of point (as shown in FIG. 5), formed on the reflective surface 134 in a form of hollow pattern (as shown in FIG. 6), or cover the complete reflective surface 134 (as shown in FIG. 7). Based on distribution of the patterned reflective layer 140 on the reflective surface 134, the patterned reflective layer 140 may be manufactured to have a characteristic of total reflection or half transmission and half reflection. More specifically, when the patterned reflective layer 140 is distributed on the reflective surface 134 in the form of point, as shown in FIG. 5, or is formed on the reflective surface 134 in the form of hollow pattern, the patterned reflective layer 140 has the characteristic of total reflection to increase a reflective index. When the patterned reflective layer 140 covers the complete reflective surface 134, as shown in FIG. 7, the patterned reflective layer 140 may have the characteristic of half transmission and half reflection or total reflection based on a desired light-emitting effect.

In addition, the embodiment does not limit on a form of the light emitting diode 120 as a light source. The light emitting diode 120 may be a light emitting diode package or a light emitting diode array based on the practical needs.

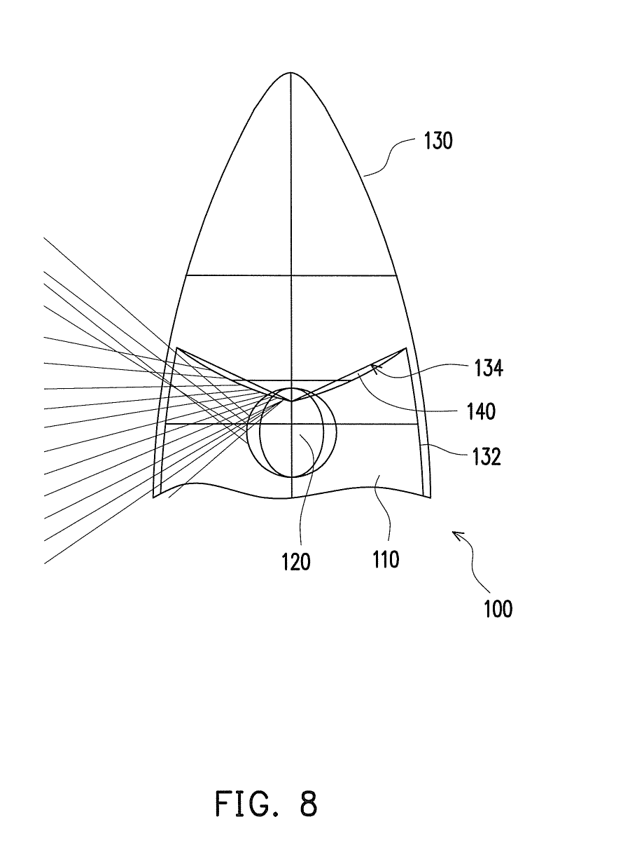

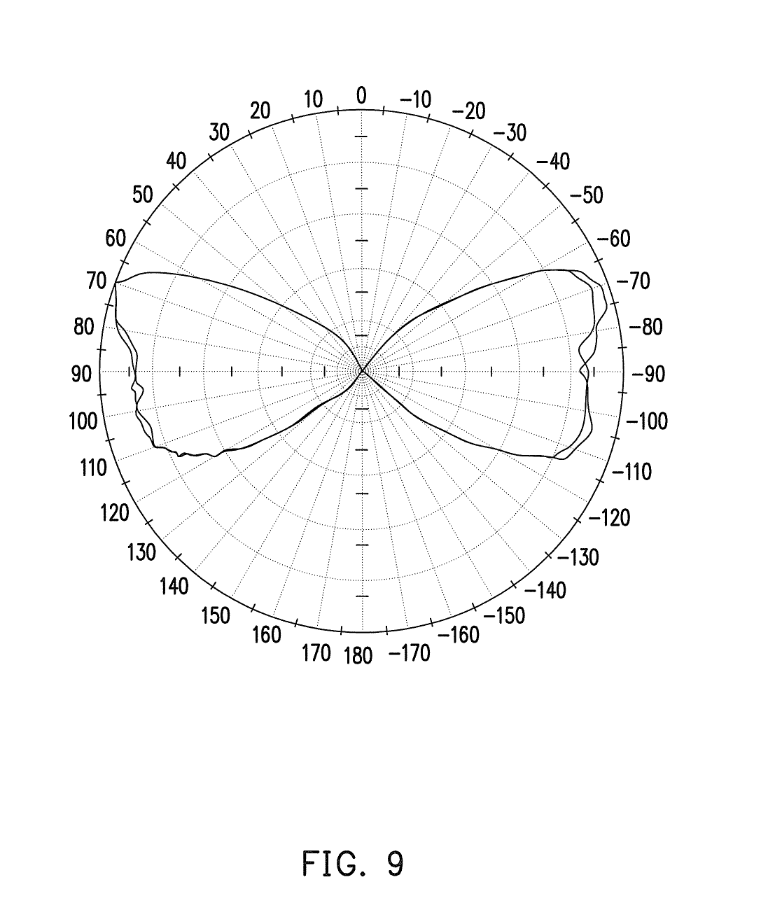

FIG. 8 is a schematic view illustrating a light track when the light emitting diode device of FIG. 1 emits a light, and FIG. 9 is a schematic view illustrating a light shape when the light emitting diode device 100 of FIG. 1 emits a light. Referring to FIGS. 1, 8, and 9 together, the sub-surfaces 136 of the reflective surface 134 of the light emitting diode device 100 of this embodiment is an inclined plane, as shown in FIG. 2, the patterned reflective layer 140 covers the complete reflective surface 134, as shown in FIG. 7, and the patterned reflective layer 140 is approximately in an arc shape. It should be noted in particular that this embodiment intends to make an upper part of the light emitting diode device 100 relatively dark and a side of the light emitting diode device 100 relatively bright, so the patterned reflective layer 140 in this embodiment uses the patterned reflective layer 140 having the characteristic of total reflection based on the needs.

When the light emitting diode 120 emits a light, since the light emitting diode 120 has a directive property, the light emitted by the light emitting diode 120 may proceed upwardly. The light is reflected when the light is emitted to the patterned reflective layer 140. Based on the principle of reflection that an incident angle is equal to a reflex angle, the light is emitted toward the side of the light emitting diode device 100, or is reflected to be emitted from a position close to the base 110. Therefore, the light shape of FIG. 9 may be achieved. The light shape of the light emitting diode device 100 ranges between −70 degrees to −110 degrees and 70 degrees to 110 degrees.

It should be noted in particular that an angle of reflection is related to an angle at which the light is emitted by the light emitting diode 120 to the reflective surface 134, and the angle at which the light is emitted by the light emitting diode 120 to the reflective surface 134 is further related to a radian or slope of the reflective surface 134. Therefore, people skilled in the art may modify a radian or slope of the sub-surfaces 136 of the reflective surface 134 and disposition of the patterned reflective layer 140 based on a degree of side-emitting or a desired light shape of the light emitting diode device 100. In addition, people skilled in the art should understand that choices on a material and manufacturing method of the patterned reflective layer 140 may also change the reflective index of the patterned reflective layer 140.

The above shows that in order for the light emitting diode device 100 to achieve the light-emitting effect desired by the designer and the corresponding light shape, people skilled in the art may selectively combine the different radians or slopes of the sub-surfaces 136 of the reflective surface 134, as shown in FIG. 2-4, the dispositions of the patterned reflective layer 140, as shown in FIGS. 5-7, and modifications to the reflexive index of the patterned reflective layer 140. A different combination may result in a different light track, light shape, and light-emitting effect.

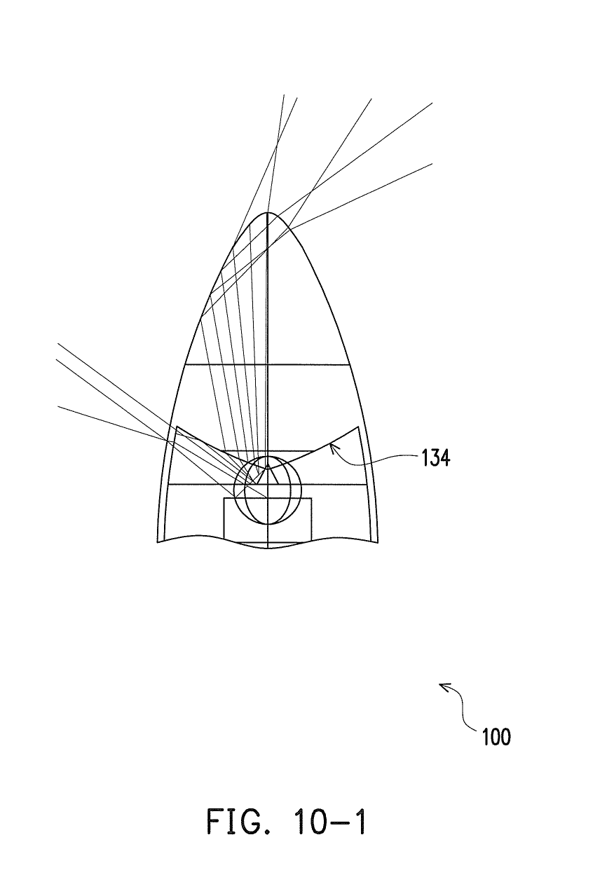

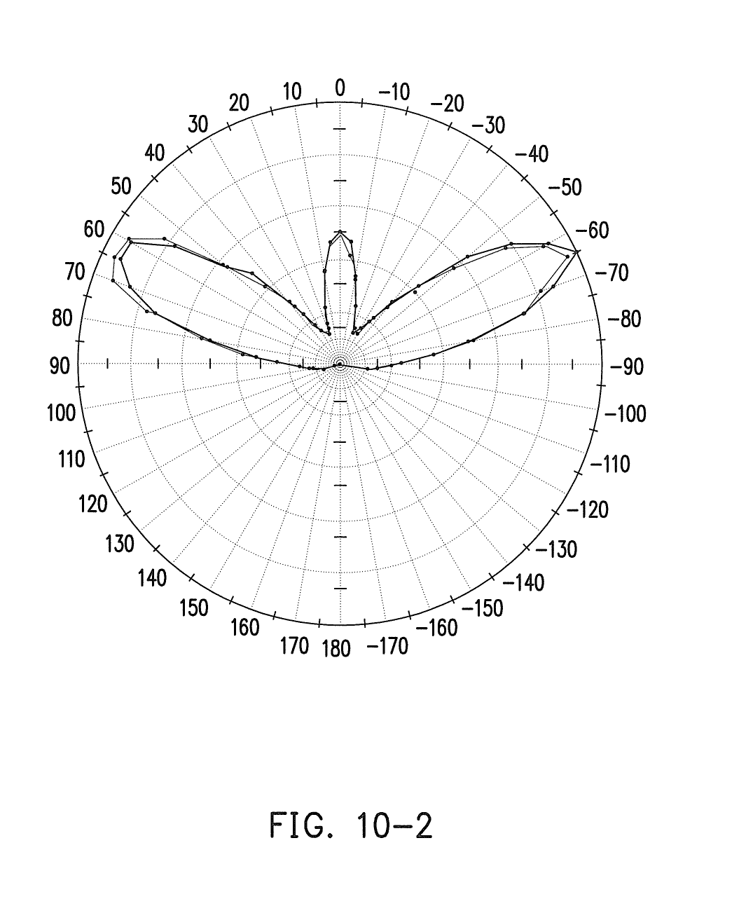

FIG. 10-1 is a schematic view illustrating a reflective surface at another slope, and FIG. 10-2 is a schematic view illustrating a light shape of the light emitting diode device of FIG. 10-1. Referring to FIGS. 10-1 and FIG. 8, it is shown that the slopes of the reflective surface 134 in the two drawings are completely different. It is also shown in the two drawings, with reference to FIGS. 10-2 and 9 simultaneously, that with different slopes of the reflective surface 134, the light emitting diode device 100 may have different light shapes. Simply speaking, as the slope of the reflective surface 134 changes, the light shape of the light emitting diode device 100 also changes.

### Second Embodiment

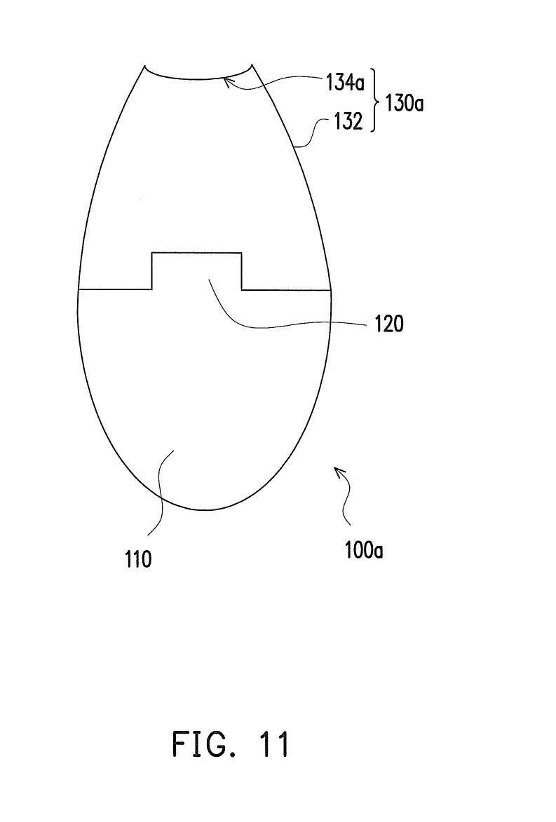

FIG. 11 is a schematic view illustrating a light emitting diode device according to a second embodiment of the disclosure. Referring to FIG. 11, the embodiment is roughly the same as the first embodiment, with a difference that a reflective surface 134a is at a top of a bulb 130a, and the reflective surface 134 is a concave surface, whereas no other part of the bulb 130a is located above the reflective surface 134a.

Different from the previous embodiment, a structure for forming the reflective surface 134 in the first embodiment is hidden in the bulb 130, whereas a structure for forming the reflective surface 134a in this embodiment is present at an external part of the bulb 130a.

The possible forms of the reflective surface 134a, the relation between the patterned reflective layer 140 and the reflective surface 134a, the characteristics of the patterned reflective layer 140, and the light tracks and light shapes as the light proceeds when a light emitting diode device 100a emits a light are already described in the first embodiment, so the details are not further reiterated in this embodiment.

### Third Embodiment

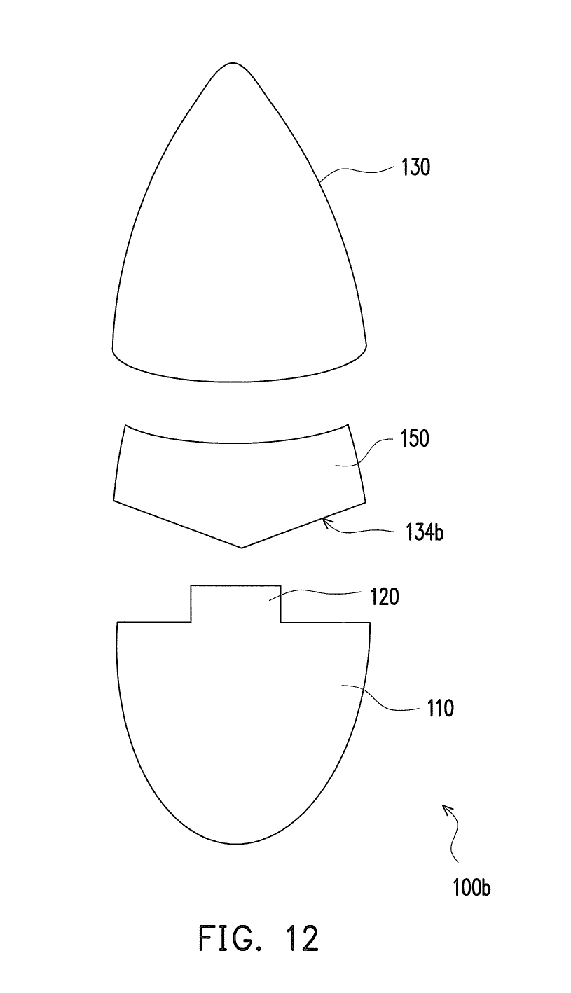

FIG. 12 is a schematic view illustrating a light emitting diode device of the disclosure according to a third embodiment. Referring to FIG. 12, this embodiment is roughly the same as the first embodiment, with a difference that a light emitting diode device 100b further includes a reflective block 150. The reflective block 150 and the bulb 130 are two independent components, and the reflective block 150 is disposed in the bulb 130 and located above the light emitting diode 120. Moreover, a reflective surface 134b is disposed on the reflective block 150. In the first embodiment, a reflective block is formed integrally with the bulb 130, so the reflective block is not specifically described. However, in this embodiment, the reflective surface 134b is particularly disposed on the reflective block 150 that is structurally independent from the bulb 130. Therefore, whether the reflective block needs to be disposed in the bulb 130, so as to change a light-emitting effect and light shape of the light emitting diode device 100b, may be determined based on practical needs without modifying a design of the bulb 130.

Simply speaking, for light emitting diode devices of the same kind, there is no need to additionally dispose the reflective block 150 in the bulb 130 if there is no need to change the light-emitting effect and light shape of the light emitting diode devices. The reflective block 150 only needs to be additionally disposed in the bulb 130 to use to change the light-emitting effect and light shape of the light emitting diode devices.

### Fourth Embodiment

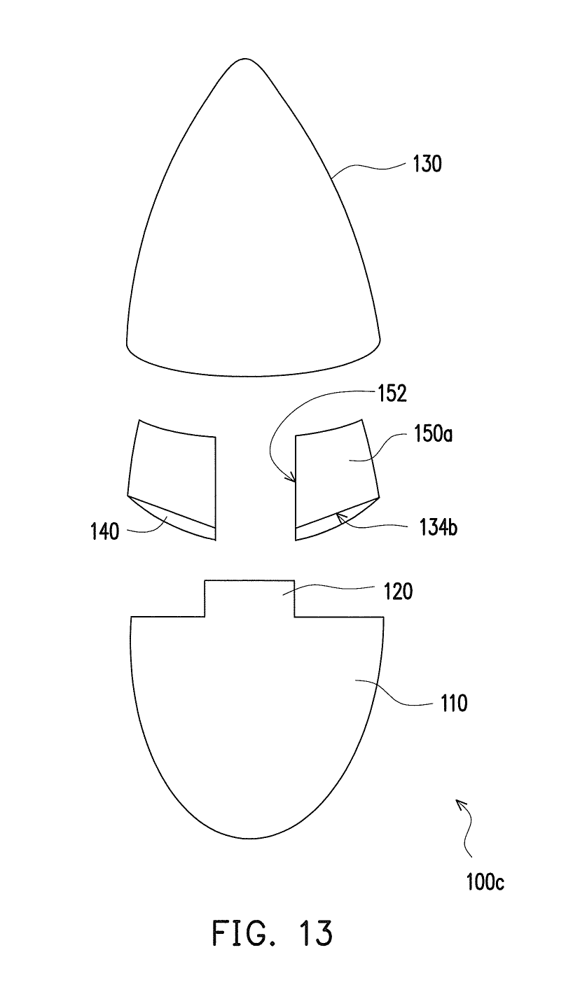

FIG. 13 is a schematic view illustrating a light emitting diode device of the disclosure according to a fourth embodiment. Referring to FIG. 13, the embodiment is roughly similar to the third embodiment, with a difference that a reflective block 150a has a through hole 152, and a position of the through hole 152 corresponds to a position of the light emitting diode 120. The through hole 152 is disposed so as to allow the patterned reflective layer 140 to cover the complete reflective surface 134b as shown in FIG. 7. When the light emitting diode 120 emits a light, a portion of the light is reflected by the reflective layer 140, and a portion of the light may be transmitted the through hole 152. In this way, a light emitting diode device 100c may have a light-emitting effect and a light shape in a broader range.

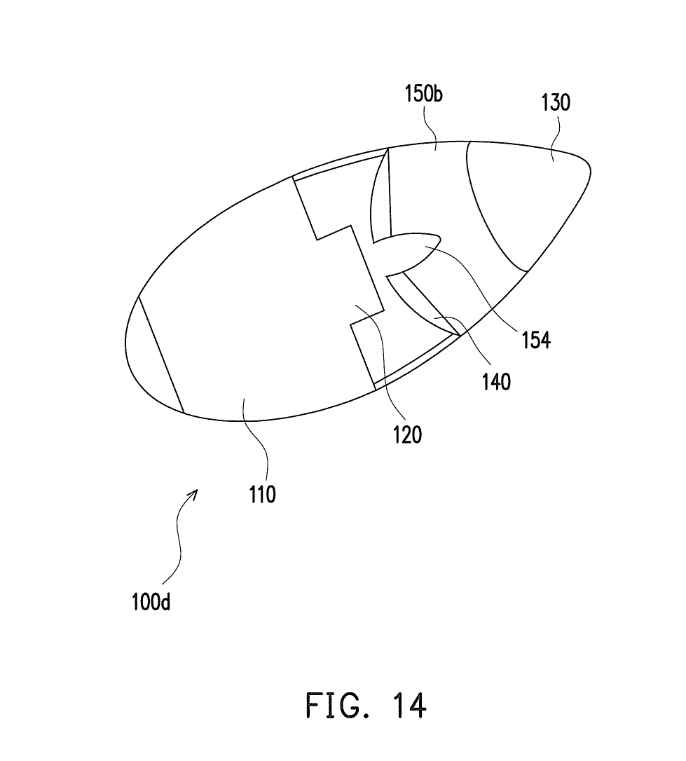

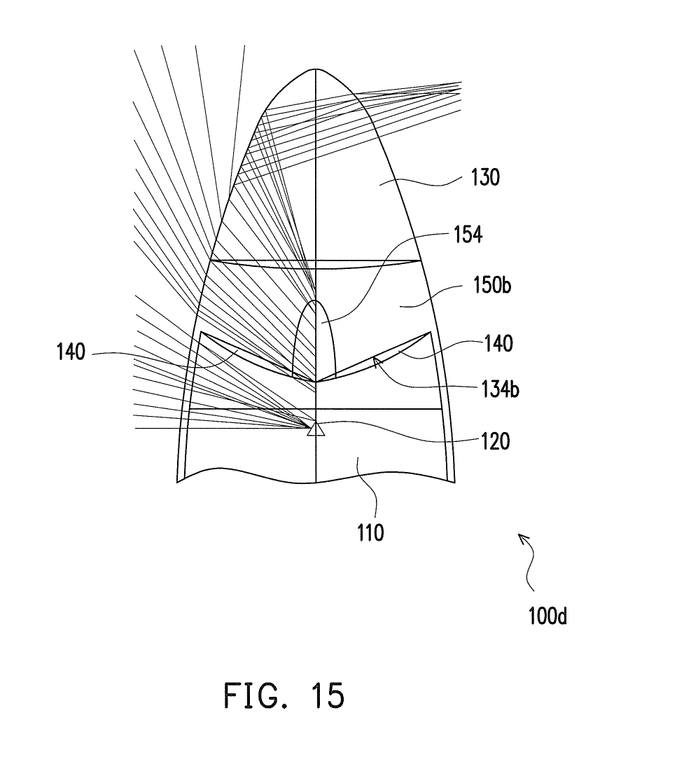

Naturally, the reflective block is not limited to be disposed with the through hole only. A reflective block 150b may be disposed with a notch 154, as shown in FIG. 14. In addition, a position of the notch 154 also corresponds to the position of the light emitting diode 120, and a surface of the notch 154 may also be an arc plane, an inclined plane, or planes with different slopes, based on the practical needs. As shown in FIGS. 14 and 15, disposition of the notch 154 may influence a path of the light, thereby changing a light-emitting effect and light shape of a light emitting diode device 100d.

Although the embodiments above are described with a candle-type light emitting diode device, the concept of the reflective surface and patterned reflective layer is generally applicable to all devices using a light source with a directive property without departing from the spirit of the disclosure.

### Fifth Embodiment

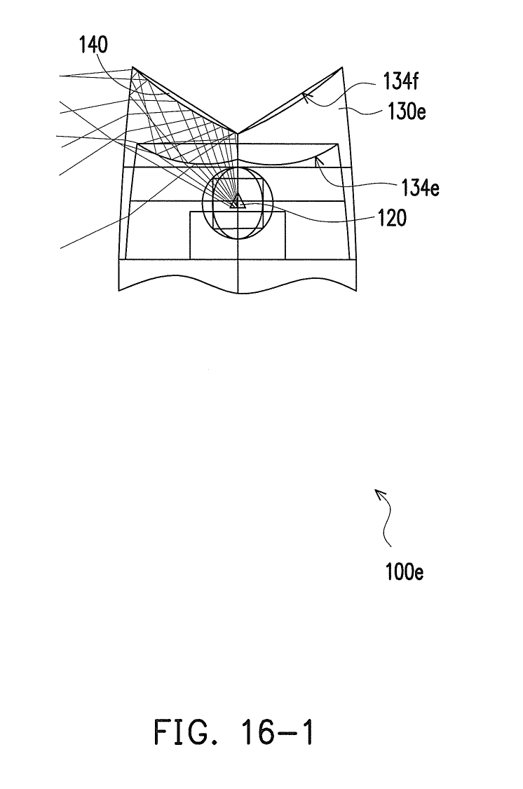

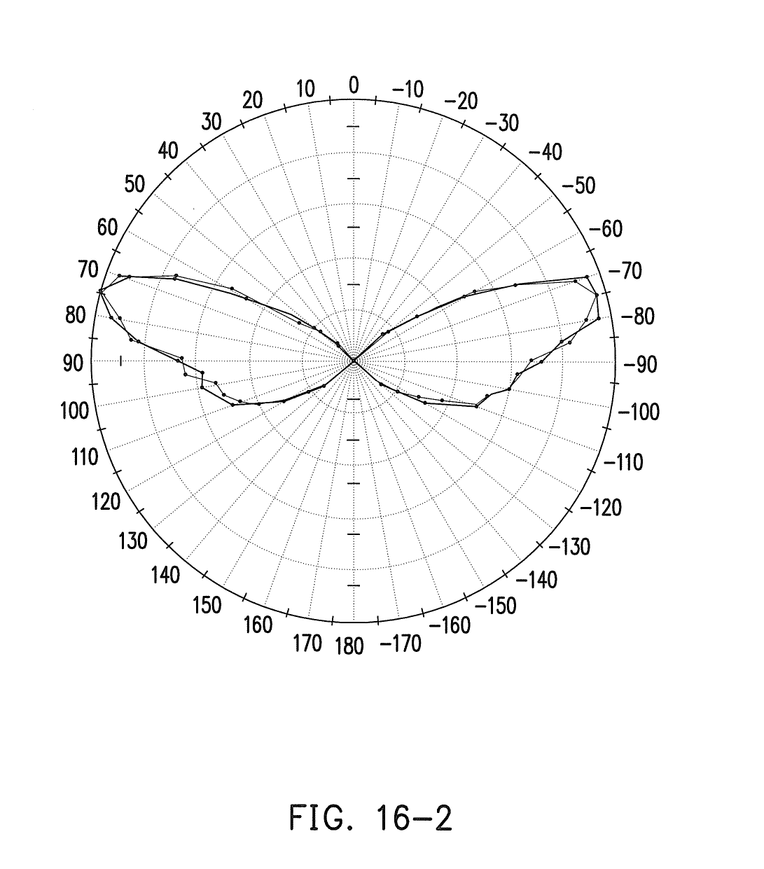

FIG. 16-1 is a schematic view illustrating a light emitting diode device of the disclosure according to a fifth embodiment, and FIG. 16-2 is a schematic view illustrating a light shape of the light emitting diode device of FIG. 16-1. The light emitting diode device of this embodiment is roughly the same as the light emitting diode device of the second embodiment, with a difference that a bulb 130e has two reflective surfaces 134e and 134f, wherein the reflective surface 134e relatively close to the light emitting diode 120 is not disposed with the patterned reflective layer 140, so the light of the light emitting diode 120 is allowed to be directly transmitted through, whereas the reflective surface 134f relatively external is coated with the patterned reflective layer 140.

In view of the foregoing, the light emitting diode device of the disclosure is disposed with the reflective surface and patterned reflective layer. In addition, different kinds of reflective surface (e.g. inclined plane, arc plane, or planes with different slopes), different kinds of patterned reflective layer (e.g. distributed in the form of point, having a hollow pattern, or complete coverage), and the patterned reflective layer with different characteristics (total reflection, or half transmission and half reflection) may be randomly combined to change the light-emitting range and light shape of the light emitting diode device, such that the light emitting diode device is allowed to have a side-emitting effect, and the light emitting range and light shape of the light emitting diode device are not limited due to the light emitting diode having a directive property.

In addition, the reflective block and bulb are integrally formed together with a manufacturing method when being manufactured. Therefore, an additional time to assemble the components may be saved. Furthermore, the reflective block and the bulb are designed to be two independent components, and the reflective block is assembled to be disposed in the bulb. In this way, given that the supplier does not change the original device structure to save the cost, the designer may selectively dispose the reflective block into the bulb based on a lighting design to allow a greater variety of applications of the light emitting diode device. In addition, the end user is allowed to conveniently assemble and dissemble the reflective block in the bulb, thereby increasing a convenience in use.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A light emitting diode device, comprising:
a base;
a light emitting diode, disposed on the base;
a bulb, disposed on the base and having a side-wall and a reflective surface, wherein the side-wall surrounds the light emitting diode, the reflective surface is located above the light emitting diode and faces the light emitting diode, and the reflective surface and the side-wall are connected; and
a patterned reflective layer, disposed on the reflective surface.

2. The light emitting diode device as claimed in claim 1, wherein the reflective surface is formed of a plurality of sub-surfaces, and the sub-surfaces intersect at one point.

3. The light emitting diode device as claimed in claim 2, wherein the sub-surfaces are a combination of at least one of an inclined plane, an arc plane, and planes with different slopes.

4. The light emitting diode device as claimed in claim 1, wherein the reflective surface is located at a top of the bulb, and the reflective surface is a concave surface.

5. The light emitting diode device as claimed in claim 1, wherein the patterned reflective layer covers at least a portion of the reflective surface.

6. The light emitting diode device as claimed in claim 1, wherein the patterned reflective layer has a characteristic of total reflection or half transmission and half reflection.

7. The light emitting diode device as claimed in claim 1, further comprising a reflective block disposed in the bulb and located above the light emitting diode, and the reflective surface is disposed on the reflective block.

8. The light emitting diode device as claimed in claim 7, wherein the reflective block and the bulb are two independent components or formed integrally.

9. The light emitting diode device as claimed in claim 7, wherein the reflective surface is formed of a plurality of sub-surfaces, and the sub-surfaces are a combination of at least one of an inclined plane, an arc plane, and planes with different slopes

10. The light emitting diode device as claimed in claim 7, wherein the reflective block has a through hole or a notch, and a position of the through hole or the notch corresponds to a position of the light emitting diode.
